(19) United States
(12) Patent Application Publication
(10) Pub. No.: US 2016/0212564 A1
(43) Pub. Date: Jul. 21, 2016

(54) Apparatus and Method for Compressing a Set of N Binaural Room Impulse Responses

(71) Applicant: Huawei Technologies Co., Ltd., Shenzhen (CN)

(72) Inventors: Simone Fontana, Munich (DE); Karim Helwani, Munich (DE); Peter Grosche, Munich (DE)

(21) Appl. No.: 15/082,087

(22) Filed: Mar. 28, 2016

Related U.S. Application Data
(63) Continuation of application No. PCT/EP2013/073931, filed on Nov. 15, 2013.

(30) Foreign Application Priority Data
Oct. 22, 2013 (EP) EP13189790.2

(51) Int. Cl. H04S 7/00; G10L 19/008

(52) U.S. Cl. CPC H04S 7/306; G10L 19/008; H04S 2420/07; H04S 2400/03

(57) ABSTRACT

An apparatus and a method for compressing a set of N binaural room impulse responses, BRIR, wherein each channel of an N channel audio signal is convolved with the corresponding compressed set of N BRIR. The apparatus may comprise at least one analyzing and compressor module adapted to separate an input binaural room impulse response signal into a first binaural signal set provided to the binauralization processing of the initial part of the BRIR (early part) and a second binaural signal set provided to the binauralization processing of the final part of the BRIR (late part) via a downmix module; a binauralization module adapted to obtain a binaural signal based on convolving the N channel audio signal with the first binaural signal set and the second binaural signal set.

### CROSS-REFERENCE TO RELATED APPLICATIONS

This application is a continuation of International Application No. PCT/EP2013/073931, filed on Nov. 15, 2013, which claims priority to European Patent Application No. EP13189790.2, filed on Oct. 22, 2013, both of which are hereby incorporated by reference in their entireties.

### TECHNICAL FIELD

The present application relates to the field of binauralization, and particularly to an apparatus and a method for compressing a set of N binaural room impulse responses (BRIR) and performing convolution of an input multichannel system with such compressed set of BRIR.

### BACKGROUND

One way to carry out binauralization is to render each loudspeaker and related feeding signal as a virtual source binaurally filtered to obtain the perception of a virtual loudspeaker. In order to binaurally render each loudspeaker and related feeding signal, one can filter the signal with the Head Related Impulse Responses (HRIR) corresponding to the position of the loudspeaker referred to the listener position.

In a second case, one can filter the signal with the Binaural Room Impulse Response, BRIR, corresponding to the position of the loudspeaker in a given room, referred to the listener position.

In the first case, the impression will be similar to a free-field listening, while in the second case, one has the impression of listening to the multichannel content in a listening room as characterized by the BRIR.

US 2012/0201389 A1 describes a processing of sound data encoded in a sub-band domain, for dual-channel playback of binaural type, in which a matrix filtering is applied so as to pass from a sound representation with multi-channels to a dual-channel representation. According to the described processing, the sound representation with multi-channels comprises considering virtual loudspeakers surrounding the head of a listener, and, for each virtual loudspeaker of at least some of the loudspeakers.

The matrix filtering of the described processing comprises a multiplicative coefficient defined by the spectrum, in the sub-band domain, of the second transfer function deconvolved with the first transfer function.

### SUMMARY

It is the object of the disclosure to provide an improved technique for binauralization solutions.

This object is achieved by the features of the independent claims. Further implementation forms are apparent from the dependent claims, the description and the figures.

According to a first aspect, an apparatus for compressing a set of N binaural room impulse responses, BRIR, is provided, wherein the apparatus is configured to convolve each channel of an N channel audio signal with the corresponding compressed set of N BRIR, the apparatus comprising at least one analyzing and compressor module adapted to separate an input binaural room impulse response signal into a first binaural signal set provided to the binauralization processing of the initial part of the BRIR (early part) and a second binaural signal set provided to the binauralization processing of the final part of the BRIR (late part) via a downmix module; a binauralization module adapted to obtain a binaural signal based on convolving the N channel audio signal with the first binaural signal set and the second binaural signal set.

The disclosure provides a separation of an input binaural room impulse response signal into two signal sets is advantageous. One set of the two signal sets is processed by a first, i.e. an early, binauralization processing and the other set of the two signal sets is processed by a second, i.e. late, binauralization processing.

Instead of early binauralization processing one could say in other words, direct binauralization processing or prompt binauralization processing or non-delayed binauralization processing. Instead of late binauralization processing one could say in other words, non-direct binauralization of the final part of the BRIR processing or postponed binauralization processing or delayed binauralization processing.

The terms “early” and “late” of the two different types of binauralization processing refer to the temporal reliance of the two processing units. The temporal reliance is relative with respect to each other of the two processing units described.

The disclosure is based on the following idea. A subband analysis of the input signal is provided, using a particular filterbank which provides analytic subband signals that can be demodulated into the baseband allowing working at a low Nyquist frequency, thus, not involving structural approximations. Separated subband convolution for the early part and late reverberation part of the IR, using the results of above analysis and truncation are processed by the binauralization module.

Further, a subband analysis of the BRIR using a filterbank and processing is provided, wherein a truncation algorithm which operates on the subband BRIRs is performed, retrieving the optimal truncation point according to perceptual parameters. This approach leads to a perceptually lossless optimal truncation.

In a first possible implementation form of the apparatus according to the first aspect, the at least one analyzing and compressor module comprises a filterbank unit adapted to filter the input binaural room impulse response signal generating a bandwidth limited binaural room impulse response signal for each subband.

The usage of a filterbank unit beneficially permits to retrieve the BRIR response for each subband.

In a second possible implementation form of the apparatus according to the first aspect as such or according to the first implementation form of the first aspect, the at least one analyzing and compressor module comprises a truncation module adapted to discard excess bits of the input binaural room impulse response signal using perceptual relevant parameters.

The truncation module of the apparatus allows providing a reduced complexity needed for calculating the binauralization in terms of multiply-add operations, or even floating-point multiply-add operation (Madd) per input samples.

In a third possible implementation form of the apparatus according to the first aspect as such or according to the any of the preceding implementation forms of the first aspect, the at least one analyzing and compressor module comprises a separation module adapted to separate the first binaural signal set provided to the early binauralization processing and the second binaural signal set provided to the late binauralization processing via a downmix module.

In a fourth possible implementation form of the according to the first aspect as such or according to the any of the preceding implementation forms of the first aspect, the at least one analyzing and compressor module comprises a Hilbert module adapted to calculate a Hilbert envelope of the first binaural signal set and/or the second binaural signal set.

In a fifth possible implementation form of the apparatus according to the first aspect as such or according to any of the preceding implementation forms of the first aspect, the at least one analyzing and compressor module comprises a demodulation module adapted to demodulate the calculated Hilbert envelope of the first binaural signal set and/or the second binaural signal set.

In a sixth possible implementation form of the apparatus according to the first aspect as such or according to any of the preceding implementation forms of the first aspect, the at least one analyzing and compressor module comprises a down-sampling module adapted to down-sample the demodulated Hilbert envelope of the first binaural signal set and/or the second binaural signal set.

In a seventh possible implementation form of the apparatus according to the first aspect as such or according to any of the preceding implementation forms of the first aspect, the downmix module is adapted to retrieve the second binaural signal set of the input binaural room impulse response signal.

This allows a further reduction concerning the number of calculation steps needed.

In an eighth possible implementation form of the apparatus according to the first aspect as such or according to any of the preceding implementation forms of the first aspect, the binauralization module is adapted to perform a convolution on the considered set of N binaural room impulse responses in a downsampled baseband analytical subband domain.

In a ninth possible implementation form of the apparatus according to the eighth implementation form of the first aspect as such or according to any of the preceding implementation forms of the first aspect, the binauralization module comprises a filterbank, which is designed to deliver for each subband analytical demodulated signal which is then downsampled at a low Nyquist frequency.

According to a second aspect, the disclosure relates to a mobile device comprising an apparatus according to the first aspect as such or according to any of the preceding implementation forms of the first aspect.

According to a third aspect, the disclosure relates to a teleconferencing device comprising an apparatus according to the first aspect as such or according to any of the preceding implementation forms of the first aspect.

According to a fourth aspect, the disclosure relates to an audio device comprising an apparatus according to the first aspect as such or according to any of the preceding implementation forms of the first aspect.

According to a fifth aspect, the disclosure relates to a method for compressing a set of N binaural room impulse responses, BRIR, wherein each channel of an N channel audio signal is convolved with the corresponding compressed set of N BRIR, the method comprising the steps of separating an input binaural room impulse response signal into a first binaural signal set provided to an early binauralization processing and a second binaural signal set provided to a late binauralization processing via a downmix module that retrieves a binaural signal from an N BRIR set; and the step of obtaining a binaural signal based on convolving the N channel audio signal with the first binaural signal set and the second binaural signal set by means of a binauralization module.

The method can be applied for multichannel audio signals. Thus, the method can be applied for stereo signals. The method can be used for decreasing computational complexity.

In a first possible implementation form of the method according to the fifth aspect, the method further comprises the step of filtering the input binaural room impulse response signal generating a bandwidth limited binaural room impulse response signal by means of a filterbank unit of the analyzing and compressor module.

Implementing the method saves computational complexity.

In a second possible implementation form of the method according to the fifth aspect as such or according to the first implementation form of the fifth aspect, the method further comprises the step of discarding excess bits of the input binaural room impulse response signal by means of a truncation module of the at least one analyzing and compressor module.

In a third possible implementation form of the method according to the fifth aspect as such or according to any of the preceding implementation forms of the fifth aspect, the method further comprises the step of calculating a Hilbert envelope of the first binaural signal set and/or the second binaural signal set by means of a Hilbert module.

In a ninth possible implementation form of the method according to the fifth aspect as such or according to any of the preceding implementation forms of the fifth aspect, the method further comprises the step of performing the convoluting of the N channel audio signal and the output binaural room impulse response signal in frequency domain by means of a fast Fourier transform module of the binauralization module.

The methods, systems and devices described herein may be implemented as software in a digital signal processor (DSP), in a micro-controller or in any other side-processor or as hardware circuit within an application specific integrated circuit (ASIC).

The disclosure can be implemented in digital electronic circuitry, or in computer hardware, firmware, software, or in combinations thereof, e.g. in available hardware of conventional mobile devices or in new hardware dedicated for processing the methods described herein.

### BRIEF DESCRIPTION OF THE DRAWINGS

Further embodiments of the disclosure will be described with respect to the following figures, in which:

FIG. 1 shows a schematic diagram of an apparatus for compressing a set of N binaural room impulse responses and convolving a multichannel input signal with such BRIR set according to an embodiment of the disclosure;

FIG. 2 shows a detailed schematic diagram of the apparatus for compressing a set of N binaural room impulse responses according to an embodiment of the disclosure;

FIG. 3 shows a schematic diagram of apparatus for compressing a set of N binaural room impulse responses and convolving a multichannel input signal with such BRIR set according to an embodiment of the disclosure;

FIG. 4 shows binaural filtering process for two virtual speakers according to an embodiment of the disclosure;

FIG. 5 shows a schematic diagram of a binauralization module of the apparatus according to an embodiment of the disclosure;

FIG. 6 shows a filterbank according to an embodiment of the disclosure;

FIG. 7 shows a plot of impulse response in smaller chunks, of same or different size for explaining the disclosure;

FIG. 8 shows a method for compressing a set of N binaural room impulse responses according to an embodiment of the disclosure; and

FIG. 9 shows a schematic diagram of a binauralization module for explaining the disclosure.

### DETAILED DESCRIPTION OF EMBODIMENTS OF THE DISCLOSURE

The units and modules of the apparatus as described herein may be realized by electronic circuits or by integrated electronic circuits or by monolithic integrated circuits, wherein all or some of the circuit elements of the circuit are inseparably associated and electrically interconnected.

FIG. 1 shows a schematic diagram of an apparatus for compressing a set of N binaural room impulse responses and performing convolution of an input multichannel system with such compressed set of BRIR according to an embodiment of the disclosure.

As illustrated in FIG. 1, an overall scheme is presented having an apparatus 100 for compressing a set of N binaural room impulse responses, BRIR, wherein the apparatus 100 is configured to convolve each channel of an N channel audio signal I1, I2, . . . , IN with the corresponding compressed set of N BRIR.

In an implementation, the apparatus 100 may comprise at least one analyzing and compressor module 10, 20 adapted to separate an input binaural room impulse response signal IBRIR into a first binaural signal set FS1 provided to an early binauralization processing and a second binaural signal set FS2 provided to a late binauralization processing via a downmix module 10-7, 20-7. The downmix module 10-7, 20-7 may be adapted to retrieve the second binaural signal set FS2 of the input binaural room impulse response signal IBRIR.

Further, the apparatus 100 may comprise a binauralization module 50 adapted to obtain a binaural signal LS, RS based on convolving the N channel audio signal I1, I2, . . . , IN with the first binaural signal set FS1 and the second binaural signal set FS2.

In a further implementation, the least one analyzing and compressor module 10, 20 may be configured for M subbands which performs lossless compression of a Binaural Room Impulse Response in the M subbands, based on perceptual parameters. The analysis of the analyzing and compressor module 10, 20 may also perform an early reverberation separation and/or a late reverberation separation resulting in a two-fold subband representation of the BRIR.

In a further implementation, the binauralization module 50 may be configured for input signal subband analysis and subband convolution of the input signal with the previously retrieved representation. The late reverberation may be processed separately, on the basis of room acoustics considerations.

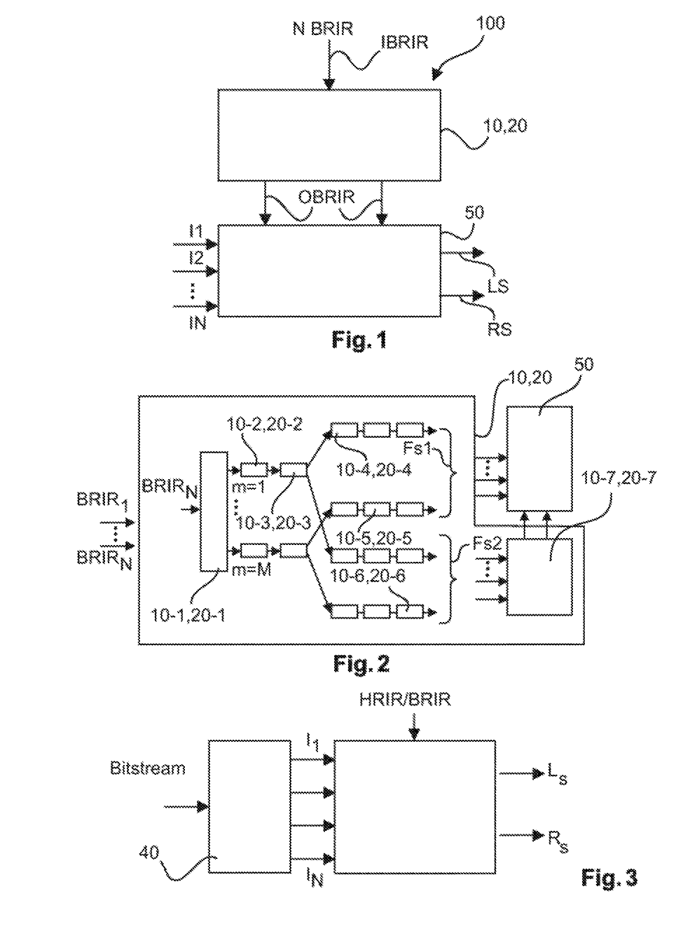

FIG. 2 shows a schematic diagram of the apparatus for compressing a set of N binaural room impulse responses according to an embodiment of the disclosure.

In a further implementation, the least one analyzing and compressor module 10, 20 may be configured for a subband analysis of the BRIR late reverberation and a subband BRIR truncation.

The least one analyzing and compressor module 10, 20 may also perform an early reverberation separation and/or a late reverberation separation on the subband truncated BRIRs.

This processing can be done offline, and the resulting representation stored in a memory unit. From the memory unit, any BRIR set can be loaded by the user and selected as the operating BRIR set, allowing user customization of the application.

In a further implementation of the present disclosure, the at least one analyzing and compressor module 10, 20 may comprise a filterbank unit 10-1, 20-1 adapted to filter the input binaural room impulse response signal (IBRIR) generating a bandwidth limited binaural room impulse response signal for each subband. As can be seen from FIG. 2, the filterbank unit 10-1, 10-2 provides M subbands resulting in M signal paths. Each signal paths comprises a truncation module 10-2, 20-2 connected to the filterbank unit 10-1, 20-1, followed by a separation module 10-3, 20-3.

Each of the M separation modules 10-3, 20-3 provides two further sub-paths (corresponding to the initial part of the BRIR (early part) and to the late part of the BRIR (late part), resulting in 2*M sub-paths. Each sub-path is provided with a Hilbert module 10-4, 20-4, a demodulation module 10-5, 20-5, and a down-sampling module 10-6, 20-6.

The first sub-path of each signal path is used as the first binaural signal set FS1, the second sub-path of each signal path is used as the second binaural signal set FS2. The first binaural signal set FS1 may be provided to the binauralization module 50. The second binaural signal set FS2 may be provided to the downmix module 10-7, 20-7 and subsequently to the binauralization module 50.

In a further implementation of the present disclosure, the at least one analyzing and compressor module 10, 20 may comprises a truncation module 10-2, 20-2 adapted to discard excess bits of the IBRIR using perceptual relevant parameters.

Binaural Room Impulse Responses Time/Frequency analysis shows a quite general property of indoor sound propagation, where the energy decay rate is higher at higher frequencies. This property is related to the following perceptual relevant parameters, which includes source directivity, absorption coefficients of commonly used materials, absorption properties of air also, and room modes ringing.

Due to these phenomena, the content of high frequencies in the late part of the BRIR may be in general negligible.

In a further implementation of the present disclosure, the at least one analyzing and compressor module 10, 20 may comprise a separation module 10-3, 20-3 adapted to separate the first binaural signal set FS1 provided to the early binauralization processing and the second binaural signal set FS2 provided to the late binauralization processing via a downmix module 10-7, 20-7.

In a further implementation of the present disclosure, the at least one analyzing and compressor module 10, 20 may comprise a Hilbert module 10-4, 20-4 adapted to calculate a Hilbert envelope of the first binaural signal set FS1 and/or the second binaural signal set FS2.

In a further implementation of the present disclosure, the at least one analyzing and compressor module 10, 20 may comprise a demodulation module 10-5, 20-5 adapted to demodulate the calculated Hilbert envelope of the first binaural signal set FS1 and/or the second binaural signal set FS2.

In a further implementation of the present disclosure, at least one analyzing and compressor module 10, 20 may comprise a down-sampling module 10-6, 20-6 adapted to down-sample the demodulated Hilbert envelope of the first binaural signal set FS1 and/or the second binaural signal set FS2.

The downmix module 10-7, 20-7 may be adapted to retrieve the second binaural signal set FS2 of the IBRIR.

The late part can be selected as corresponding to a particular BRIR, obtained by diffuse field averaging or by synthesis. In a first embodiment of this disclosure, late reverberation is chosen as one of the BRIR-related late reverberation. Here, the underlying assumption is that the late part does not depend on the position of the loudspeaker but is essentially the same for all positions within the room.

While the late reverberation is a property of the room, and in first approximation does not depend on the measurement position, the early part of the impulse response, carrying the direct front and the early reflections, is modeled considering the position of the listener and the speaker.

The early part of the BRIR refers to a particular speaker and then to an input channel. This means each input signal may be filtered with the early BRIR in order to provide realistic reproduction.

According to an implementation of the present disclosure, the late part can be applied directly to the downmix. As the late part of the BRIR is the longest one, performing the filtering on the output channel, two channels, and not on the input channels, i.e. 22 channels, results in complexity reduction. The late part does not depend on the position of the loudspeaker but is in principle the same for all positions within the room.

The early-part transition point can be fixed, or computed for each subband, using various methods. The variability of the early-part transition point is less predictable in a subband context, so in an implementation of the present disclosure the early and/or late transition point is fixed and set to 80 milliseconds (ms) or to any value between 60 and 110 ms.

As another implementation of the present disclosure, the subband representation is used in the following processing steps also for the late part of the BRIR.

The binauralization module 50 may be adapted to perform a convolution on the considered set of N binaural room impulse responses in a downsampled baseband analytical subband domain.

In order to further reduce the number of filter taps for each subband BRIR (both for early and late parts), each BRIR is further transformed into an analytical signal, baseband modulated and properly down sampled in order to optimize the subband BRIR taps number for successive subband convolution in the binauralizer.

This approach, common in communication applications, is new for the audio domain. Similar processing is also integrated in the analysis filterbank of the binauralizer and applied to the input signal. Then, the convolution operation can be efficiently applied in baseband.

FIG. 3 shows a schematic diagram of apparatus for compressing a set of N binaural room impulse responses and performing convolution of an input multichannel system with such compressed set of BRIR according to an embodiment of the disclosure.

A bitstream representation of a multichannel audio signal, for example Advanced Audio Coding (AAC), is decoded in a decoder module 40 in order to obtain the multi-channel audio signal or N channel audio signal. The signal is then provided to a binauralization module 50. Each channel is filtered with the HRIR or the compressed BRIR (by the at least one analyzing and compressor module 10, 20) between the associated loudspeaker position and the two ears of a listener to obtain the binaural signal LS, RS.

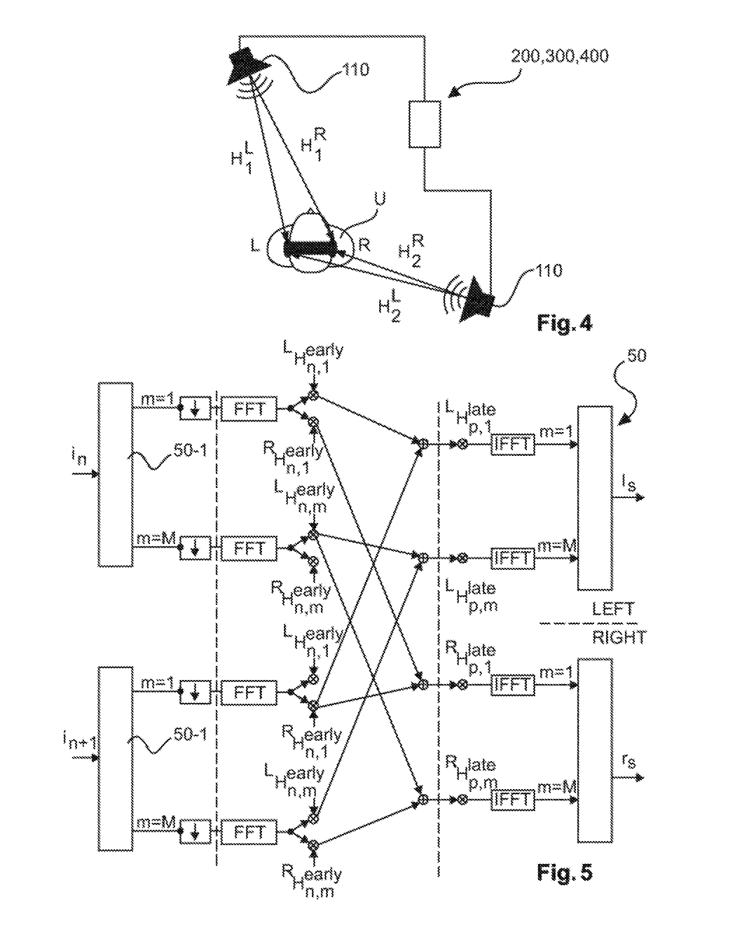

FIG. 4 shows a schematic diagram of audio device for explaining the disclosure.

Two loudspeakers 110 of a teleconferencing device 300 generate a sound field for a user U. The same circuit maybe used for a mobile device 200 or an audio device 400. As an alternative to loudspeaker reproduction, binaural headphones may be used.

FIG. 5 shows a schematic diagram of a binauralization module of the apparatus for compressing a set of N binaural room impulse responses and performing convolution of an input multichannel system with such compressed set of BRIR according to an embodiment of the disclosure.

The binauralization module 50 may operate as follows. The implementation of the analysis filterbank is used on each input signal and delivers baseband subband analytical signals. Based on the bandwidth of each resulting signal, optimal downsampling at a low Nyquist frequency is performed.

Fast convolution with the left and right corresponding early baseband subband analytical BRIRs is carried out on the resulting signal. This operation has a low cost, due to the short length of signals in this representation.

As a next step, summing in the subband frequency domain of all the subband contributions from all the channels into the output LEFT and RIGHT channel is performed, retrieving two subband baseband subband analytical signals defined as early subband outputs.

Subsequently, subband fast convolution of the early subband outputs with the late reverberation is performed. The length of the baseband subband analytical late reverberation is in general higher than the early subband output length. Zero padding or a partitioned convolution can then be applied.

Inverse Fast Fourier Transformation (IFFT) is performed for two output signals, subsequently the steps of upsampling, band modulating and inverse Hilbert transforming in order to retrieve the signal corresponding to each subband analytical signal.

Subsequently, summing up the subband contributions for retrieving the two output full bandwidth binaural signals is conducted.

According to the choices of latency/complexity, also the early part convolution can be performed as partitioned convolution, partitioning the early subband responses.

The binauralization module 50 may comprise a filterbank 50-1, which is designed to deliver for each subband analytical demodulated signal which is downsampled at a Nyquist frequency.

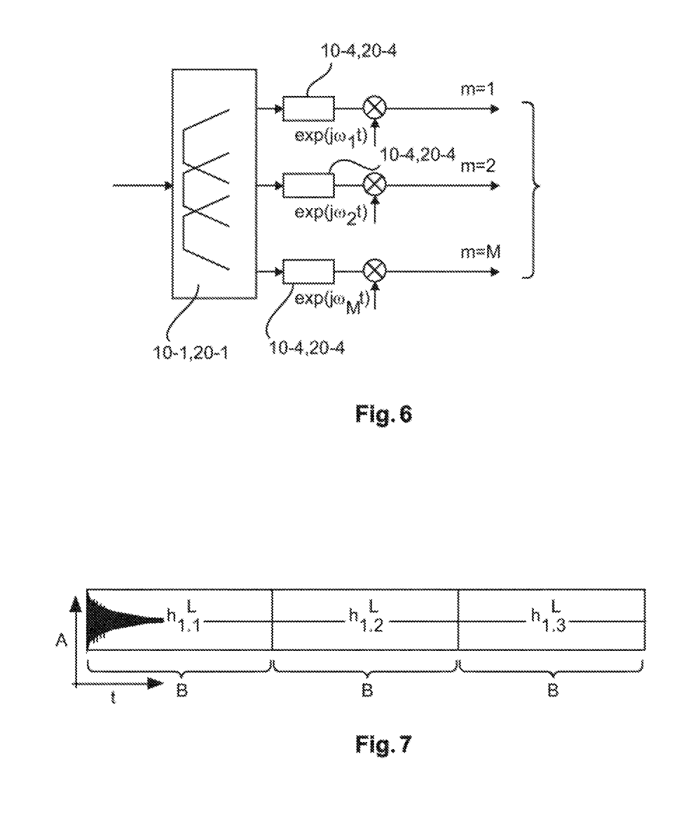

FIG. 6 shows a schematic diagram of the filterbank according to an embodiment of the disclosure.

In order to represent the signals that are involved in the binauralization process in a subband domain, an analysis filterbank unit 10-1, 20-1 is used. The filterbank unit 10-1, 20-1 involves the splitting of the signal in 64 subbands.

The filterbank unit 10-1, 20-1 may be preferably chosen to fulfill the orthogonality property and to allow a perfect reconstruction using a suitable synthesis filter.

The filterbank unit 10-1, 20-1 may split a real input signal into M frequency bands. The orthogonality of the circuit of the filterbank unit 10-1, 20-1 allows making use of the Parseval′ theorem. Further, the convolution can be considered as decoupled in the respective subband domain.

On the output of the filterbank unit 10-1, 20-1 a subsequent Hilbert transformation is performed on each of the subband signals. The Hilbert-transformed signals are complex and their spectra vanish for negative frequencies.

Performing the analysis filtering and the Hilbert-transformation can be combined to single step in which the input signal is convolved, preferably in the frequency domain, with the Hilbert-transformed analysis filterbank.

The fast convolution in the frequency domain offers the possibility to demodulate the subband analytic signals into the baseband by a simple frequency shift with neglectable computational complexity. Otherwise, the demodulation is done by a multiplication with an exponential.

Analyzing a BRIR with a filterbank unit 10-1, 20-1, it is possible to retrieve the BRIR response for each subband. In order to determine the point where to truncate each subband BRIR, attention has to be paid not to discard useful samples.

The filterbank 50-1 of the binauralization module 50 may have the same arrangement and features as described in FIG. 6 and the corresponding description above with respect to the filterbank unit 10-1, 20-1.

The reverberation time, T60, is defined as the time the direct sound to be attenuated of 60 decibel (dB), which is considered as a detection threshold. One way to achieve perceptually lossless truncation is then to truncate each response at the reverberation time.

Reverberation time can be computed according to state of the art algorithms, and eventually substituted with T20 or T30. The Early Decay Time is defined as the time the direct sound to be attenuated of 60 dB, extrapolated from the first 10 dB of the decay; this parameter is considered as representative of the perception of reverberation and it is in general lower than T60. A less conservative solution compared to T60 truncation, which achieve higher compression, is then to truncate the response at the EDT.

The BRIR is truncated in each subband individually according to one of these perceptually motivated principles. The resulting representation is a set of subband responses of non uniform length, which can be seen as a compressed version of the original BRIR, with no detection or perceptual lost.

This representation is more effective than one obtained i.e., by truncating the BRIR without performing a subband decomposition because the reverberation time shows strong dependency on frequency. For high frequencies, reverberation time is generally significantly shorter than for low frequencies. Therefore, in the subband domain, low frequency reverberation can be captured using long BRIRs, in high frequency subbands very short BRIRs are sufficient to achieve perceptual losslessness. Because the exceeding samples in the high frequencies are removed, one achieves a high compression of the BRIR. Keeping the perceptually relevant samples in low frequencies, the quality is optimal.

FIG. 7 shows a plot of impulse response in smaller chunks, of same or different size for explaining the disclosure.

The x-axis denoted time t, the y-axis corresponds to the amplitude A of the signal.

Methods to provide low complexity, low latency and lossless convolution aim at partitioning the impulse response in smaller chunks B, of same or different sizes, in order to speed up the process involving less input buffering and take advantage of parallel processing.

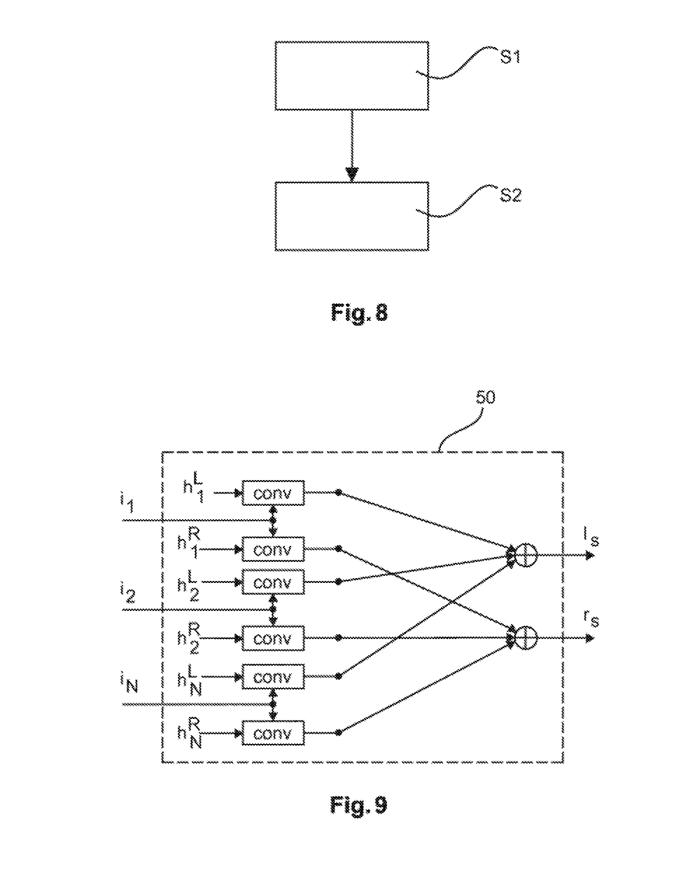

FIG. 8 shows a method for compressing a set of N binaural room impulse responses according to an embodiment of the disclosure.

A method for compressing a set of N BRIR, wherein each channel of an N channel audio signal I1, I2, . . . , IN is convolved with the corresponding compressed set of N BRIR, the method comprising the steps of:

As a first step of the method, separating S1 an input binaural room impulse response signal IBRIR into a first binaural signal set FS1 provided to an early binauralization processing and a second binaural signal set FS2 provided to a late binauralization processing via a downmix module 10-7, 20-7 that retrieves a binaural signal from an N BRIR set;

As a second step of the method, obtaining S2 a binaural signal LS, RS based on convolving the N channel audio signal I1, I2 . . . IN with the first binaural signal set FS1 and the second binaural signal set FS2 by means of a binauralization module 50.

The method is also performed for performing convolution of an input multichannel system with such compressed set of BRIR.

FIG. 9 shows a schematic diagram of a binauralization module for explaining the disclosure.

Fast convolution algorithms are proposed with the goal to reduce the computational complexity of this operation. In general, three criteria are involved in characterizing binauralization solutions, including complexity, quality, and latency.

From the foregoing, it will be apparent to those skilled in the art that a variety of methods, systems, computer programs on recording media, and the like, are provided.

The present disclosure also supports a computer program product including computer executable code or computer executable instructions that, when executed, causes at least one computer to execute the performing and computing steps described herein.

Many alternatives, modifications, and variations will be apparent to those skilled in the art in light of the above teachings. Of course, those skilled in the art readily recognize that there are numerous applications of the disclosure beyond those described herein.

While the present disclosure has been described with reference to one or more particular embodiments, those skilled in the art recognize that many changes may be made thereto without departing from the scope of the present disclosure. It is therefore to be understood that within the scope of the appended claims and their equivalents, the disclosures may be practiced otherwise than as specifically described herein.

In the claims, the word “comprising” does not exclude other elements or steps, and the indefinite article “a” or “an” does not exclude a plurality. A single processor or other unit may fulfill the functions of several items recited in the claims.

The mere fact that certain measures are recited in mutually different dependent claims does not indicate that a combination of these measured cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems.

What is claimed is:

1. An apparatus for compressing a set of N binaural room impulse responses (BRIR), wherein the apparatus is configured to convolve each channel of an N channel audio signal with the corresponding compressed set of N BRIR, the apparatus comprising:
at least one analyzing and compressor module adapted to separate an input binaural room impulse response signal, IBRIR, into a first binaural signal set provided to an early binauralization processing and a second binaural signal set provided to a late binauralization processing via a downmix module; and
a binauralization module adapted to obtain a binaural signal based on convolving the N channel audio signal with the first binaural signal set and the second binaural signal set.

2. The apparatus according to claim 1, wherein the at least one analyzing and compressor module comprises a filterbank unit adapted to filter the IBRIR generating a bandwidth limited binaural room impulse response signal for each subband.

3. The apparatus according to claim 1, wherein the at least one analyzing and compressor module comprises a truncation module adapted to discard excess bits of the IBRIR using perceptual relevant parameters.

4. The apparatus according to claim 1, wherein the at least one analyzing and compressor module comprises a separation module adapted to separate the first binaural signal set provided to the early binauralization processing and the second binaural signal set provided to the late binauralization processing via a downmix module.

5. The apparatus according to claim 1, wherein the at least one analyzing and compressor module comprises a Hilbert module adapted to calculate a Hilbert envelope of at least one of the first binaural signal set and the second binaural signal set.

6. The apparatus according to claim 5, wherein the at least one analyzing and compressor module comprises a demodulation module adapted to demodulate the calculated Hilbert envelope of at least one of the first binaural signal set and the second binaural signal set.

7. The apparatus according to claim 6, wherein the at least one analyzing and compressor module comprises a down-sampling module adapted to down-sample at least one of the demodulated Hilbert envelope of the first binaural signal set and the second binaural signal set.

8. The apparatus according to claim 1, wherein the downmix module is adapted to retrieve the second binaural signal set of the input binaural room impulse response signal.

9. The apparatus according to claim 1, wherein the binauralization module is adapted to perform a convolution on the considered set of N binaural room impulse responses in a downsampled baseband analytical subband domain.

10. The apparatus according to claim 1, wherein the binauralization module comprises a filterbank configured to deliver for each subband analytical demodulated signal which is downsampled at a Nyquist frequency.

11. A method for compressing a set of N binaural room impulse responses (BRIR), wherein each channel of an N channel audio signal is convolved with the corresponding compressed set of N BRIR, the method comprising:
separating, by at least one analyzing and compressor module, an input BRIR (IBRIR) into a first binaural signal set provided to an early binauralization processing and a second binaural signal set provided to a late binauralization processing via a downmix module that retrieves a binaural signal from an N BRIR set; and
obtaining, by a binauralization module, a binaural signal based on convolving the N channel audio signal with the first binaural signal set and the second binaural signal set.

12. The method according to claim 11, further comprising filtering, by a filterbank unit of the analyzing and compressor module, the IBRIR generating a bandwidth limited binaural room impulse response signal.

13. The method according to claim 11, further comprising discarding, by a truncation module of the at least one analyzing and compressor module, excess bits of the IBRIR.

14. The method according to claim 11, further comprising calculating, by a Hilbert module, a Hilbert envelope of at least one of the first binaural signal set and the second binaural signal set.

15. The method according to claim 11, further comprising performing, by a fast Fourier transform module of the binauralization module, the convolving of the N channel audio signal and an output binaural room impulse response signal (OBRIR) in frequency domain.
